(19) United States
(12) Patent Application Publication
(10) Pub. No.: US 2005/0025329 A1
(43) Pub. Date: Feb. 3, 2005

(54) Earphone and earphone attachment

(76) Inventor: Vincent K. Lee, Taipei (TW)

Correspondence Address: DENNISON, SCHULTZ & DOUGHERTY;612 Crystal Square 4, 1745 Jefferson Davis Highway, Arlington, VA, 22202-3417, US

(21) Appl. No.: 10/748,131

(22) Filed: Dec. 31, 2003

(30) Foreign Application Priority Data
Jul. 30, 2003 (TW) 092120882

(51) Int. Cl. H04R 25/00

(52) U.S. Cl. 381/370; 381/371; 381/374; 381/380

(57) ABSTRACT

A speaker main body has a first magnetic member and a second magnetic member. The user can place the first and second magnetic members on the two sides of his or her ear. Through the magnetic force, the speaker main body is properly fixed onto the user's ear. The present invention can also be an ear-attachment device that can be attached to an ear phone. The ear-attachment device also comprises a first magnetic member and a second magnetic member.

### BACKGROUND OF THE INVENTION

1. Field of the Invention

The present invention relates to a technique and method of fastening an earphone and, more particularly, relates to an earphone for a mobile phone.

2. Description of the Related Art

There are many methods to place an earphone on a user's ear. The most popular method is to directly plug a speaker of the earphone into the user's ear. Taking an ear phone of a mobile phone as an example, a user can place the earphone into his or her ear directly instead of placing the mobile phone near to his or her ear when talking. However, this method is not suitable for everyone, as human ears have many various shapes and sizes. The speaker might fall from the ears of some people. Furthermore, such an insertion method tends to be quite uncomfortable for the user. Therefore, there are other improved methods, such as an ear hanger disclosed in U.S. Pat. No. 5,729,615. The ear hanger does help the speaker of the earphone stay on the user's ear. However, the ear hanger places more pressure on the ear of a user who wears glasses. Furthermore, the same problem still exists: since human ears have very different shapes and sizes, the ear hanger might also fall off from some people's ears.

Therefore, it is desirable to provide an improved earphone to mitigate and/or obviate the aforementioned problems.

### SUMMARY OF THE INVENTION

The object of the present invention is to provide an earphone which uses two magnetic members to fasten a speaker or a main body of the earphone onto two sides of a user's ear, so that the two magnetic members are placed on two sides of a user's ear. The present invention is suitable for any ear shape or size, and provides more comfort for ears of different thickness. One important feature of the present invention is that the earphone doesn't utilize a clip to fasten the speaker onto the user's ear, since a clip design is not suitable for all the variations in size and shape of ears.

To achieve these objectives, the earphone of the present invention includes a speaker and a main body. The speaker is embedded in the main body. The earphone, which is the main body, further comprises a first magnetic member and a second magnetic member. A user can place the first and second magnetic member on two sides of his or her ear, and through the magnetic force between the first and second magnetic member, the speaker main body is properly fixed onto the user's ear.

The present invention can also be employed as an earphone attachment device. The earphone attachment device comprises a first magnetic member and a second magnetic member, and the earphone attachment device can be attached onto the earphone.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic drawing of a first embodiment of the present invention.

FIG. 2 is a schematic drawing of applying the first embodiment of the present invention.

FIG. 3 is a schematic drawing of a second embodiment of the present invention.

FIG. 4 is a schematic drawing of a third embodiment of the present invention.

FIG. 5 is a schematic drawing of applying the third embodiment of the present invention.

FIG. 6 is a schematic drawing of a fourth embodiment of the present invention.

FIG. 7 is a schematic drawing of a fifth embodiment of the present invention.

FIG. 8 is a schematic drawing of applying the fifth embodiment of the present invention.

FIG. 9 is a schematic drawing of applying a sixth embodiment of the present invention.

FIG. 10 is a schematic drawing of applying a seventh embodiment of the present invention.

FIG. 11 is a schematic drawing of applying an eighth embodiment of the present invention.

### DETAILED DESCRIPTION OF THE PREFERRED EMBODIMENT

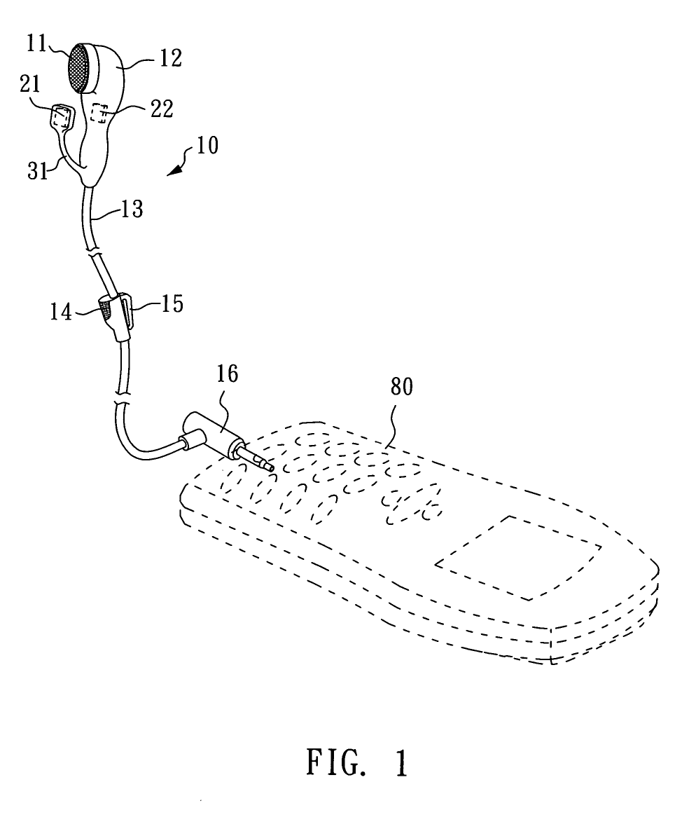

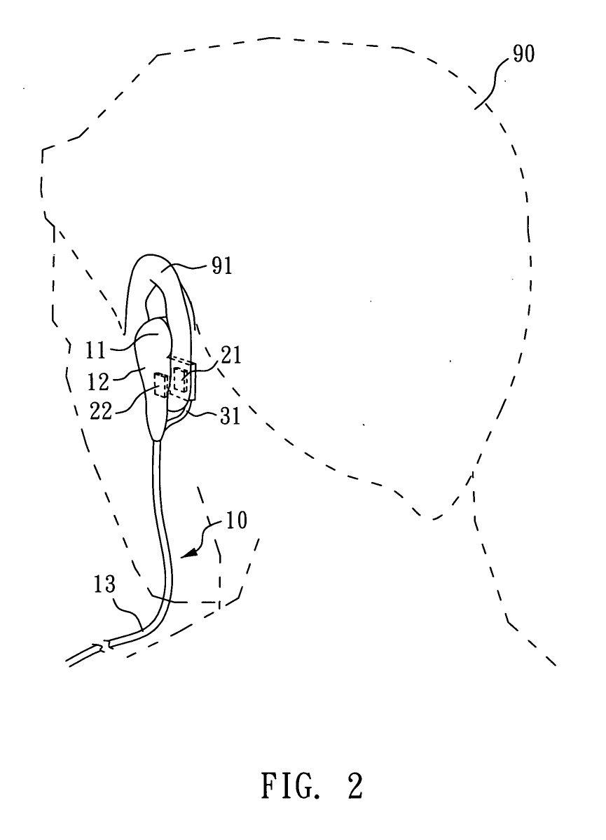

Please refer to both FIG. 1 and FIG. 2. FIG. 1 is a schematic drawing of a first embodiment of the present invention. FIG. 2 is a schematic drawing of applying the first embodiment of the present invention. An earphone 10 in the present invention is used in a mobile phone 80. The earphone 10 comprises a speaker 11, a main body 12, a transmission wire 13, a microphone 14, a clip 15 and a plug 16. The speaker 11 is embedded in the main body 12, and the transmission cable 13 is connected to the main body 12, the microphone 14 and the plug 16. A user 90 can use the speaker 11 and the microphone 14 to talk on the phone while driving without needing to hold the mobile phone 80.

A main characteristic of the present invention is the fastening of the speaker 11 and the main body 12 onto an ear 91 of the user 90. The following embodiments are therefore explained in relation to this characteristic.

In the present invention, the main body 12 further comprises a first magnetic member 21 and a second magnetic member 22. In a first embodiment, the main body 12 further comprises a first extension body 31, and the first magnetic member 21 is placed on the first extension body 31, and the second magnetic member 22 is placed on the main body 12. As shown in FIG. 2, the user 90 can put the first magnetic member 21 and the second magnetic member 22 on two sides of his or her ear. The first magnetic member 21 and the second magnetic member 22 provide a magnetic force to fasten the main body 12 onto the ear 91 of the user 90. Since different users may have different ear sizes and shapes, the first extension body 31 is preferably made of a soft material, such as rubber or soft plastic.

It is very easy to attach the first magnetic member 21 onto the first extension body 31, and to place the second magnetic member onto the main body 12. Such attachment methods are not important to the present invention, and so no further description in this respect is provided. One thing to be noted is that the first magnetic member 21 and the second magnetic member 22 are both preferably made of a magnetic material, or one is made of a magnetic material and the other is made of metal so that the first magnetic member 21 and the second magnetic member 22 provide an attractive magnetic force.

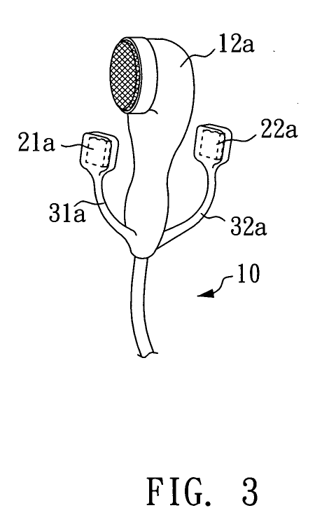

Please refer to FIG. 3 FIG. 3 is a schematic drawing of a second embodiment of the present invention. The difference between the first embodiment and the second embodiment is that a main body 12a of an earphone 10a further comprises a second extension body 32a, and a second magnetic member 22a is placed on the second extension body 32a. Similarly, the user 90 can put the first magnetic member 21a and the second magnetic member 22a on two sides of his or her ear (not shown).

The following embodiments describe an earphone attachment device 50 which uses the above-mentioned technique, but the user can just purchase the earphone attachment device and combine it with any normal earphone to achieve the same functionality as the above-mentioned embodiment.

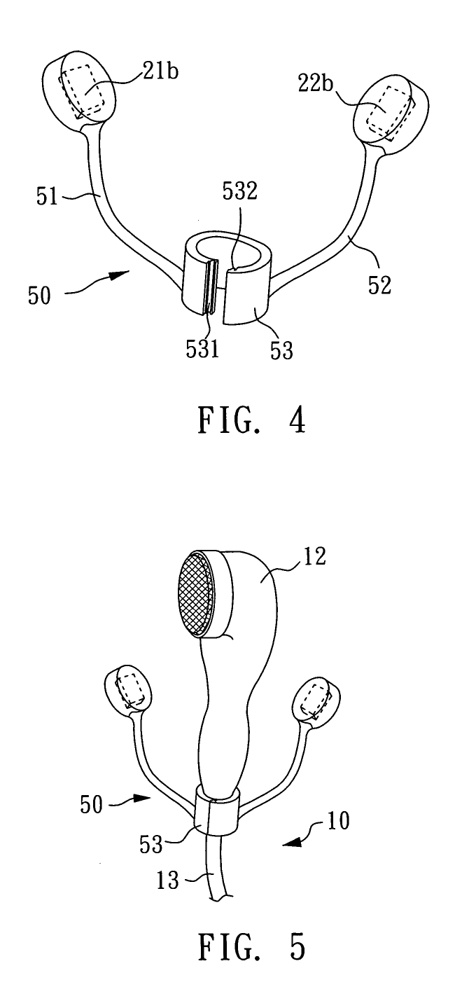

Please refer to FIG. 4 and FIG. 5. FIG. 4 is a schematic drawing of a third embodiment of the present invention. FIG. 5 is a schematic drawing of applying the third embodiment of the present invention. The earphone attachment device 50 is attached to the earphone 10 below the main body 12, or on the transmission wire 13 by an attaching member 53. The attaching member 53 is a hollow cylinder, and the attaching member 53 has a jack at one end and a plug at the other end, so the earphone attachment device 50 can be detached from or attached to the earphone 10.

The attaching member 53 is further connected to a first extension body 51 and a second extension body 52. The first magnetic member 21b is placed on the first extension body 51, and the second magnetic member 22b is placed on the second extension body 52. As shown in the second embodiment depicted in FIG. 3, the earphone attachment device 50 is attached to the earphone.

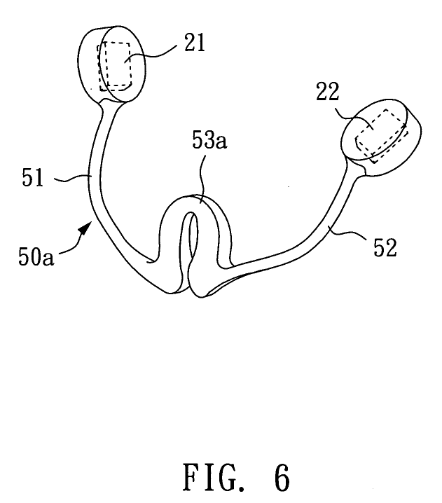

Please refer to FIG. 6. FIG. 6 is a schematic drawing of a fourth embodiment of the present invention. The difference between the third embodiment and the fourth embodiment is that an attaching member 53a of an earphone attachment device 50a has a clip-like structure.

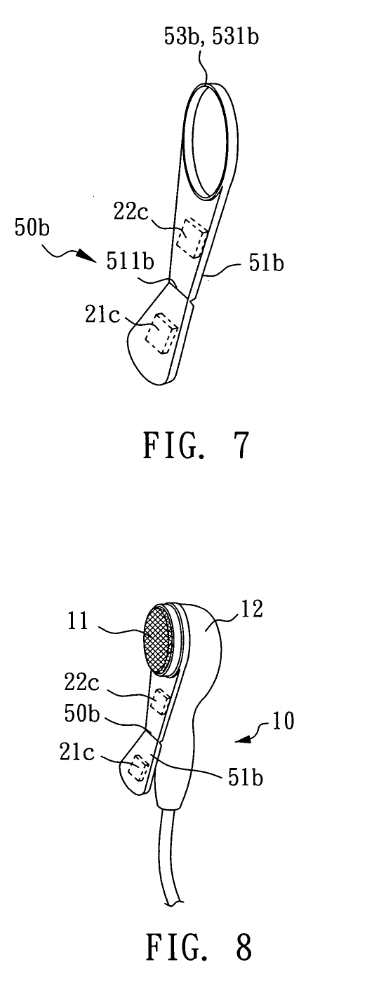

Please refer to FIG. 7 and FIG. 8. FIG. 7 is a schematic drawing of a fifth embodiment of the present invention. FIG. 8 is a schematic drawing of applying the fifth embodiment of the present invention. In the fifth embodiment, an attaching member 53b of an earphone attachment device 50b is an annular body 531b, which can be placed around the main body 12 (near the speaker 11) or around the speaker 11. Furthermore, the attaching member 53b is connected to a first extension body 51b, and both a first magnetic member 21c and a second magnetic member 22c are placed on the first extension body 51b. The attaching member 53b and the first extension body 31 are preferably made of a soft material such as rubber, soft plastic or silica gel. In this manner, the annular body 531b can be stretched for placement around the main body 12 (near the speaker 11), or around the speaker 11. Furthermore, a middle part 511b of the first extension body 51b is flexible, so that the first magnetic member 21c and the second magnetic member 22c can be placed on two sides of the user's ear (not shown). However, the earphone attachment device 50b can also be fixed on the earphone 10 so that the earphone attachment device 50b and the earphone 10 can be sold as a single unit.

The above-mentioned five embodiments all use two magnetic members to fasten the speaker or the main body onto the user's ear. However, as the speaker itself is a magnet, the inventor has a realized a way to reduce the two magnetic members to one magnetic member (which is preferably a magnet), and the following embodiments illustrate this design.

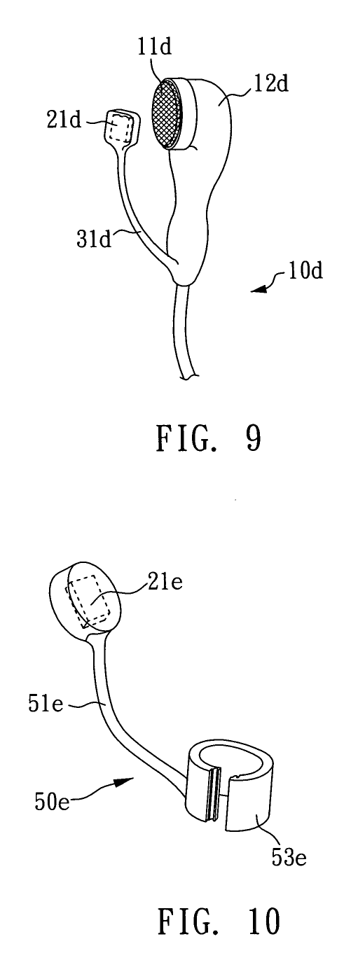

Please refer to FIG. 9. FIG. 9 is a schematic drawing of applying a sixth embodiment of the present invention. An earphone 10d (similar to the earphone 10 shown in FIG. 3) comprises a speaker 11d, a main body 12d, a first extension body 31d and a first magnetic member 21d without the second extension body and the second magnetic body. The first magnetic member 21d and a magnet in the speaker 11d provide an attractive magnetic force between each other.

Please refer to FIG. 10. FIG. 10 is a schematic drawing of applying a seventh embodiment of the present invention. An earphone attachment device 51e has a similar structure with the earphone shown in FIG. 4, but the earphone attachment device 51e only has a first extension body 31e and a first magnetic member 21e without the second extension body and the second magnetic body.

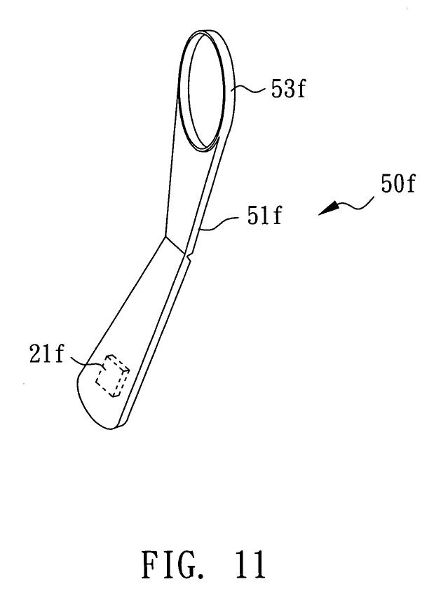

FIG. 11 is a schematic drawing of applying an eighth embodiment of the present invention. An earphone attachment device 51f has a similar structure with the earphone shown in FIG. 7, but a first extension body 31f of an attaching member 53f only has a first magnetic member 21f placed thereon.

Although the present invention has been explained in relation to its preferred embodiments, it is to be understood that many other possible modifications and variations can be made without departing from the spirit and scope of the invention as hereinafter claimed. For example, the earphone of the present invention is not only used for a mobile phone but may also be used with stereo equipment (such as a walkman or a radio). Furthermore, the earphone is not limited to wired earphones, but may also be employed in wireless earphones.

1. An earphone comprising a speaker and a main body, the speaker embedded in the main body, characterized in that the main body further comprises a first magnetic member and a second magnetic member, wherein a user can place the first and second magnetic member onto two sides of his or her ear, and through a magnetic force between the first and second magnetic members the speaker main body is properly fixed onto the user's ear.

2. The earphone as claimed in claim 1, wherein the main body further comprises a first extension body, and the first magnetic member is placed on the first extension body.

3. The earphone as claimed in claim 2, wherein the second magnetic member is placed on the main body.

4. The earphone as claimed in claim 2, wherein the main body further comprises a second extension body, and the second magnetic member is placed on the second extension body.

5. The earphone as claimed in claim 1, wherein the main body further comprises a first extension body, and the first and the second magnetic members are both placed on the first extension body.

6. An earphone comprising a speaker and a main body, the speaker embedded in the main body, the earphone characterized in that the main body further comprises a first magnetic member, wherein a user can place the first magnetic member on two sides of his or her ear, and through a magnetic force between the first magnetic member and the speaker, the speaker main body is properly fixed on the user's ear.

7. The earphone as claimed in claim 6, wherein the main body further comprises a first extension body, and the first magnetic member is placed on the first extension body.

8. An earphone attachment device for placement on an ear, the earphone attachment device comprising an attaching member for attaching to the earphone and a first magnetic member.

9. The earphone attachment device as claimed in claim 8 further comprising a second magnetic member, the first and the second magnetic member capable of being placed on two sides of the ear.

10. The earphone attachment device as claimed in claim 8, wherein the attaching member is detachable from the earphone.

11. The earphone attachment device as claimed in claim 8, wherein the attaching member is fixed on the earphone and cannot be detached.

12. The earphone attachment device as claimed in claim 8, wherein the attaching member is further connected to a first extension body and the first magnetic member is placed on the first extension body.

13. The earphone attachment device as claimed in claim 9, wherein the attaching member is further connected to a first extension body and the second extension body, and the first magnetic member is placed on the first extension body and the second magnetic member is placed on the second extension body.

14. The earphone attachment device as claimed in claim 9, wherein the attaching member is further connected to a first extension body, and the first magnetic member and the second magnetic member are both placed on the first extension body.

15. A method of fastening an earphone on a user's ear, comprising providing a magnetic force to fasten a speaker of the earphone on the user's ear.

16. The method as claimed in claim 15, wherein the magnetic force is provided between a magnetic member and the speaker.

17. The method as claimed in claim 15, wherein the magnetic force is provided between two magnetic members.
